(19) United States
(12) Patent Application Publication
(10) Pub. No.: US 2022/0391596 A1
(43) Pub. Date: Dec. 8, 2022

(54) INFORMATION PROCESSING COMPUTER-READABLE RECORDING MEDIUM, INFORMATION PROCESSING METHOD, AND INFORMATION PROCESSING APPARATUS

(71) Applicant: FUJITSU LIMITED, Kawasaki-shi (JP)

(72) Inventor: Hiyori YOSHIKAWA, Kawasaki (JP)

(73) Assignee: FUJITSU LIMITED, Kawasaki-shi (JP)

(21) Appl. No.: 17/738,011

(22) Filed: May 6, 2022

(30) Foreign Application Priority Data
Jun. 3, 2021 (JP) 2021-093644

(51) Int. Cl. G06F 40/40; G06F 40/289

(52) U.S. Cl. CPC G06F 40/40; G06F 40/289

(57) ABSTRACT

A non-transitory computer readable recording medium stores therein a program that causes a computer to execute a process including: acquiring a plurality of word strings relating to a target sentence; inputting each of a plurality of combined sentences for which each of the acquired word strings is combined with the target sentence, and the target sentence into a language model, generated by using a machine learning; calculating, based on a difference between each distribution of an output result when each of the combined sentences is input into the language model, confidence in output when the target sentence is input into the language model; and outputting, based on the calculated confidence, an output result when the target sentence is input into the language model.

### CROSS-REFERENCE TO RELATED APPLICATION(S)

This application is based upon and claims the benefit of priority of the prior Japanese Patent Application No. 2021-093644, filed on Jun. 3, 2021, the entire contents of which are incorporated herein by reference.

### FIELD

The embodiment discussed herein is related to an information processing computer program, an information processing method, and an information processing apparatus.

### BACKGROUND

Conventionally, natural language processing using a language model (LM) generated by machine learning has been advanced. The natural language processing using such a language model has exhibited high performance in various tasks such as summarizing news articles and responding in interactive systems.

Language models generated by machine learning are not good at dealing with irregular situations such as untrained cases. For this reason, the natural language processing using a language model may produce incorrect output such as outputting what is not written in the text in summarizing a news article or responding that is not based on the facts in an interactive system.

On the natural language processing using such a language model, as a conventional technology for suppressing incorrect output, one that calculates confidence of the output of the language model and refrains from responding if the confidence is below a threshold has been known. A related art example is described in non-patent literature of Amita Kamath et al., Selective Question Answering under Domain Shift, Computer Science Department, Stanford University, 2020.

### SUMMARY

According to an aspect of an embodiment, a non-transitory computer readable recording medium stores therein a program that causes a computer to execute a process including: acquiring a plurality of word strings relating to a target sentence; inputting each of a plurality of combined sentences for which each of the acquired word strings is combined with the target sentence, and the target sentence into a language model, generated by using a machine learning; calculating, based on a difference between each distribution of an output result when each of the combined sentences is input into the language model, confidence in output when the target sentence is input into the language model; and outputting, based on the calculated confidence, an output result when the target sentence is input into the language model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram for explaining an overview of an embodiment;

FIG. 2 is a block diagram illustrating a functional configuration example of an information processing apparatus according to the embodiment;

FIG. 3 is a flowchart illustrating operation examples of the information processing apparatus according to the embodiment;

FIG. 4 is an explanatory diagram for explaining the calculation of confidence and output of response according to the confidence;

FIG. 5 is an explanatory diagram for explaining a specific example of responses for each case; and

FIG. 6 is an explanatory diagram for explaining one example of a computer configuration.

### DESCRIPTION OF EMBODIMENT

However, in the above-described conventional technology, the confidence may be calculated to be high even when the language model produced incorrect output. Thus, when the confidence close to the case of the correct answer is calculated, the incorrect output is not suppressed and is output, whereby there has been a problem in that it is not sufficient to optimize the output.

Preferred embodiments of the present invention will be explained with reference to accompanying drawings. In the embodiment, constituents having identical functions are given identical reference signs, and their redundant explanations are omitted. The information processing computer program, the information processing method, and the information processing apparatus described in the following embodiment merely illustrate examples and are not intended to limit the embodiment. The following embodiment may be combined appropriately as far as it does not cause any inconsistency.

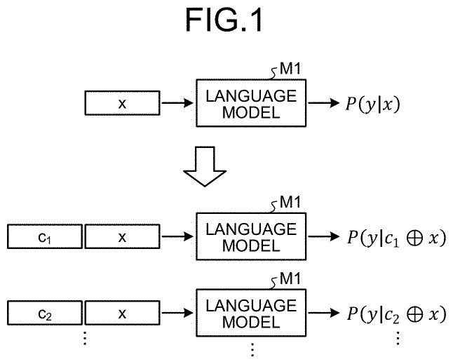

FIG. 1 is an explanatory diagram for explaining an overview of the embodiment. As illustrated in FIG. 1, the information processing apparatus according to the embodiment performs natural language processing using a language model M1 generated by machine learning on an input sentence x that is a processing target sentence.

The natural language processing using the language model M1 may be any of summarizing news articles, responding in interactive systems, translating in translation systems, and the like. For example, in summarizing a news article, inputting an original sentence into the language model M1 as the input sentence x obtains, as the output (y) of the language model M1, information (probability distribution of word strings P(y|x)) concerning the summary sentence. In responding in an interactive system, inputting a question sentence into the language model M1 as the input sentence x obtains the probability distribution of word strings concerning the response sentence as the output of the language model M1. In translating in a translation system, inputting an original sentence into the language model M1 as the input sentence x obtains the probability distribution of word strings concerning the translation sentence as the output of the language model M1. In the embodiment, the case of obtaining the response in an interactive system using the language model M1 is illustrated.

The information processing apparatus according to the embodiment performs whether to output the output result (response sentence based on probability distribution P(y|x)) when the input sentence x is input into the language model M1 as described below and suppresses incorrect output to assist optimization of the output of the language model M1.

First, the information processing apparatus acquires, as a plurality of word strings relating to the input sentence x, dummy contexts (c₁, c₂, . . . ) concerning the input sentence x by using a corpus or the like that is a database in which various documents are accumulated. Then, the information processing apparatus combines each of the acquired dummy contexts (c₁, c₂, . . . ) with the input sentence x to obtain combined sentences (c₁+x, c₂+x, . . . ). The combined sentences for which the dummy contexts (c₁, c₂, . . . , cⱼ) are combined are also expressed as (1) in the following.

cⱼ⊕x (1)

Subsequently, the information processing apparatus inputs each combined sentence into the language model M1 and obtains the probability distribution of the word string in the respective output results. The probability distribution of the word string obtained by inputting each combined sentence into the language model M1 is also expressed as (2) in the following.

P(y|cⱼ⊕x) (2)

Then, the information processing apparatus compares the probability distribution of each of the combined sentences and obtains the difference (degree of change) between them. This difference in the probability distribution represents context-dependency of the dummy contexts (c₁, c₂, . . . , cⱼ) with respect to the output result when the input sentence x is input into the language model M1.

For example, the context-dependency of the dummy contexts (c₁, c₂, . . . , cⱼ) is higher as the difference in the probability distribution is larger, meaning that the output result of the language model M1 is influenced by the dummy context. Thus, the confidence of the output result when the input sentence x is input into the language model M1 is lower as the difference in the probability distribution is larger, and it can be assumed that the output result is likely to be incorrect.

The context-dependency of the dummy contexts (c₁, c₂, . . . c₁) is lower as the difference in the probability distribution is smaller, meaning that the output result of the language model M1 is not influenced by the dummy context. Thus, the confidence of the output result when the input sentence x is input into the language model M1 is higher as the difference in the probability distribution is smaller, and it can be assumed that the output result is not likely to be incorrect.

The information processing apparatus utilizes such context-dependency of the dummy contexts (c₁, c₂, . . . , cⱼ) with respect to the output result and calculates, based on the difference in the probability distribution of each combined sentence, the confidence in the output when the input sentence x is input into the language model M1.

Then, the information processing apparatus outputs, based on the calculated confidence, the output result (response sentence based on the probability distribution P(y|x)) when the input sentence x is input into the language model M1. For example, when the confidence exceeds a predetermined threshold, the information processing apparatus assumes that the output result (response sentence) by the language model M1 is not likely to be incorrect, and outputs the obtained response sentence. When the confidence does not exceed a predetermined threshold, the information processing apparatus assumes that the output result (response sentence) by the language model M1 is likely to be incorrect and suppresses the output of the obtained response sentence. In this way, the information processing apparatus can assist optimization of the output of the language model M1.

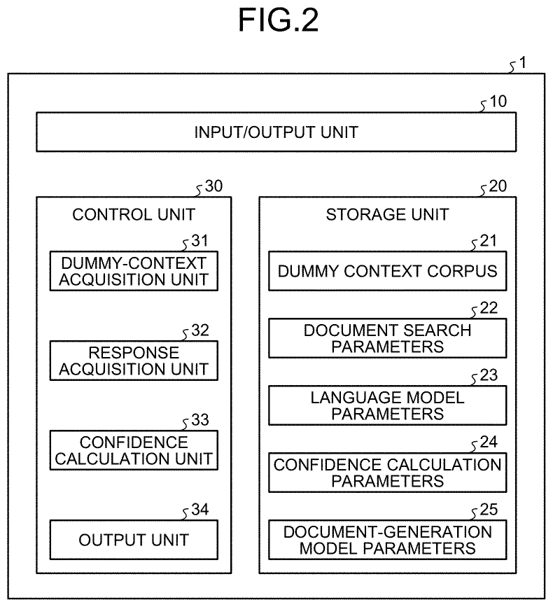

FIG. 2 is a block diagram illustrating a functional configuration example of the information processing apparatus according to the embodiment. As illustrated in FIG. 2, an information processing apparatus 1 includes an input/output unit 10, a storage unit 20, and a control unit 30.

The input/output unit 10 controls an input/output interface such as a graphical user interface (GUI) when the control unit 30 performs inputting and outputting of various information. For example, the input/output unit 10 controls the input/output interface with input devices such as a keyboard and a microphone and display devices such as a liquid crystal display device that are connected to the information processing apparatus 1. In addition, the input/output unit 10 controls a communication interface that performs data communication with external devices connected via a communication network such as a (local area network (LAN).

For example, the information processing apparatus 1 receives input of the input sentence x via the input/output unit 10. The information processing apparatus 1 outputs a processing result (for example, response sentence) for the input sentence x via the input/output unit 10.

The storage unit 20 corresponds to a semiconductor memory device such as a random-access memory (RAM) and a flash memory and to a storage device such as a hard disk drive (HDD). The storage unit 20 stores therein a dummy context corpus 21, document search parameters 22, language model parameters 23, confidence calculation parameters 24, and document-generation model parameters 25.

The dummy context corpus 21 is a corpus for obtaining dummy contexts (c₁, c₂, . . . , cⱼ) relating to the input sentence x. This corpus may be not stored in the information processing apparatus 1, and a corpus that an external information processing apparatus stores therein may be used via the input/output unit 10, for example.

The document search parameters 22 are parameter information used for the search for obtaining the dummy contexts (c₁, c₂, . . . , cⱼ) relating to the input sentence x from the dummy context corpus 21. For example, the document search parameters 22 include a threshold for determining the presence of the relation by the similarity of the document when searching for a document.

The language model parameters 23 are parameter information relating to the language model M1. For example, the language model parameters 23 are parameters for constructing a machine learning model concerning the language model M1 such as a gradient boosting tree and a neural network.

The confidence calculation parameters 24 are parameter information used in a calculation formula when the confidence is calculated. For example, the confidence calculation parameters 24 include coefficient values (weight values) used in the calculation formula when the confidence is calculated.

The document-generation model parameters 25 are parameter information concerning the machine learning model (document generation model) that generates (outputs) dummy document data relating to the input document data. For example, the document-generation model parameters 25 are parameters for constructing the machine learning model concerning the document generation model such as a gradient boosting tree and a neural network.

The control unit 30 includes a dummy-context acquisition unit 31, a response acquisition unit 32, a confidence calculation unit 33, and an output unit 34. The control unit 30 can be implemented with a central processing unit (CPU), a micro processing unit (MPU), or the like. The control unit 30 can also be implemented with a hard-wired logic such as an application-specific integrated circuit (ASIC) and a field-programmable gate array (FPGA).

The dummy-context acquisition unit 31 is a processing unit that acquires, based on a target sentence (input sentence x), a plurality of word strings relating to the target sentence, that is, the dummy contexts (c₁, c₂, c₃, . . . ).

Specifically, the dummy-context acquisition unit 31 acquires, based on the input sentence x, a plurality of dummy contexts as the dummy contexts relating to the input sentence x in order of similarity according to the parameters included in the document search parameters 22 from the dummy context corpus 21. As one example, the dummy-context acquisition unit 31 provides two encoders that vectorize the input sentence x and the document contexts cⱼ included in the dummy context corpus 21, respectively, and employs k pieces of contexts cⱼ in order of close similarity of the encoded vectors as the dummy contexts.

The dummy-context acquisition unit 31 may acquire a plurality of dummy contexts based on the output result (probability distribution of word strings) obtained by inputting the input sentence x into the machine learning model (document generation model) constructed based on the document-generation model parameters 25.

The response acquisition unit 32 is a processing unit that obtains, based on the output result when the input sentence x is input into the language model M1, the response sentence for the input sentence x. Specifically, the response acquisition unit 32 inputs information concerning the input sentence x into the language model M1 constructed based on the language model parameters 23 and obtains the probability distribution concerning the word strings (line of words) corresponding to the response sentence from the language model M1. As one example, the response acquisition unit 32 inputs the input sentence x into the language model M1 and obtains a prediction label (y₀) concerning each word and a probability mass function such as the following expression (3) indicating the distribution of the label probability. The response acquisition unit 32 obtains the response sentence based on the probability distribution (probability mass function) of the prediction label (y₀) output from the language model M1 in such a manner.

f(y)=P(y|x) (3)

The confidence calculation unit 33 is a processing unit that performs the calculation of the above-described confidence. Specifically, the confidence calculation unit 33 combines each of the dummy contexts (c₁, c₂, . . . ) acquired in the dummy-context acquisition unit 31 with the input sentence x and obtains the combined sentences (c₁+x, c₂+x, . . . ). Then, the confidence calculation unit 33 inputs each combined sentence into the language model M1 constructed based on the language model parameters 23 and obtains the probability distribution corresponding to the respective combined sentences. As one example, the confidence calculation unit 33 inputs the combined sentences exemplified by (1) into the language model M1 and obtains the prediction label (yⱼ) and the probability mass function (probability distribution) such as the following expression (4) indicating the distribution of the label probability.

f(y)=P(y|cⱼ⊕x) (4)

Then, the confidence calculation unit 33 calculates, based on the difference between each probability distribution when each of the combined sentences is input into the language model M1, the confidence in the output when the input sentence x is input into the language model M1.

Specifically, the confidence calculation unit 33 obtains, in the prediction label y₀, the variance of the probability distribution after giving k pieces of dummy contexts (cⱼ) as the following expression (5). The confidence calculation unit 33 assumes the variance value based on each probability distribution obtained in such a manner to be the index value of the confidence C.

$$C = - \frac{1}{k} {\sum }_{j = 1}^{k} {( P ( {y}_{0} \vert {c}_{j} ⊕ x ) - μ )}^{2} ( μ = \frac{1}{k} {\sum }_{j = 1}^{k} P ( {y}_{0} \vert {c}_{j} ⊕ x ) ) \qquad ( 5 )$$

In addition, the confidence calculation unit 33 obtains the average of KL (Kullback-Leibler) divergence as a distance between the probability distribution before and after the change of adding dummy contexts as the following expression (6). The confidence calculation unit 33 may assume the distance value based on each probability distribution obtained in such a manner to be the index value of the confidence C.

$$C = - \frac{1}{k} {\sum }_{j = 1}^{k} {D}_{KL} ( {f}_{j} \vert \vert f ) \qquad ( 6 )$$

The output unit 34 is a processing unit that outputs, based on the confidence C calculated by the confidence calculation unit 33, the output result (response sentence based on the prediction label (y₀)) when the input sentence x is input into the language model M1 to a display and external devices via the input/output unit 10. Specifically, the output unit 34 compares the confidence C calculated by the confidence calculation unit 33 with a predetermined threshold value (β), and when C<β, refrains from outputting the response sentence. The output unit 34 outputs the response sentence when C≥β.

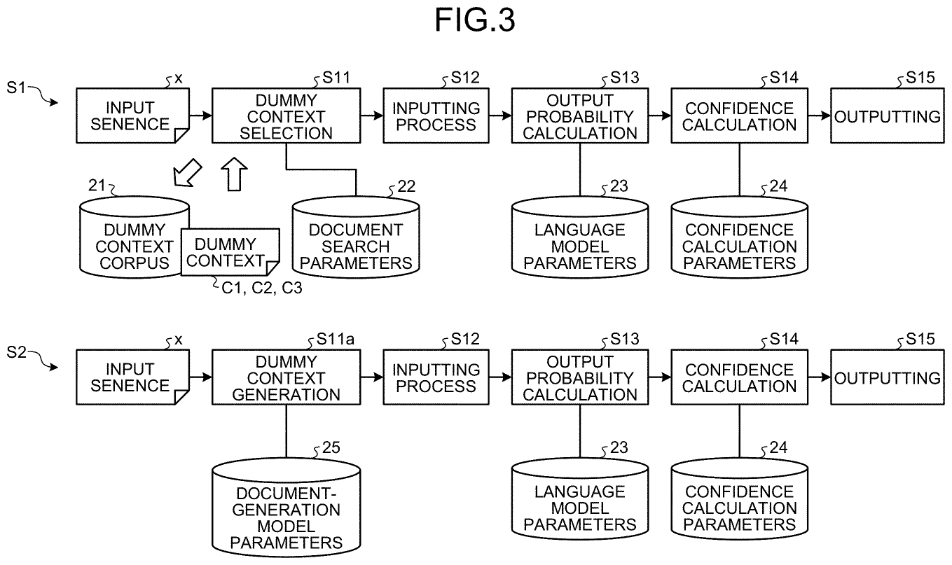

FIG. 3 is a flowchart illustrating operation examples of the information processing apparatus 1 according to the embodiment. In FIG. 3, S1 is a flowchart when generating dummy contexts using the dummy context corpus 21. In FIG. 3, S2 is a flowchart when generating dummy contexts using the machine learning model (document generation model) constructed based on the document-generation model parameters 25.

First, the case (S1) of generating dummy contexts using the dummy context corpus 21 will be described. As illustrated in S1, when the processing is started, the dummy-context acquisition unit 31 extracts, based on the input sentence x, a plurality of dummy contexts in order of similarity from the dummy context corpus 21. Then, the dummy-context acquisition unit 31 selects, for example, three dummy contexts (c₁, c₂, c₃), in descending order of similarity according to the parameters included in the document search parameters 22 (S11).

Then, the response acquisition unit 32 and the confidence calculation unit 33 perform an inputting process of inputting the input sentence x and the combined sentences for which the dummy contexts are combined with the input sentence x into the language model M1 constructed based on the language model parameters 23 (S12). As a result, the response acquisition unit 32 obtains the prediction labels (y₀) and the probability distribution of labels when the input sentence x and the combined sentences are input into the language model M1. The confidence calculation unit 33 performs output probability calculation of the probability distribution corresponding to each combined sentence (S13).

Then, the confidence calculation unit 33 calculates, based on the difference between each probability distribution obtained by the output probability calculation, the confidence C in the output when the input sentence x is input into the language model M1 (S14). Subsequently, the output unit 34 outputs, based on the confidence C calculated by the confidence calculation unit 33, the output result when the input sentence x is input into the language model M1 (S15).

Next, the case (S2) of generating dummy contexts using a document generation model constructed based on the document-generation model parameters 25 will be described. As illustrated in S2, when the processing is started, the dummy-context acquisition unit 31 constructs the machine learning model (document generation model) based on the document-generation model parameters 25.

Then, the dummy-context acquisition unit 31 generates a plurality of dummy contexts based on the output result (probability distribution of word strings) obtained by inputting the input sentence x into the constructed machine learning model (document generation model) (S11a). For example, the dummy-context acquisition unit 31 generates the dummy contexts by changing the combination of each word for which the probability value in the probability distribution is greater than a specific threshold value. The processing subsequent to S11a is performed in the same manner as that in S1.

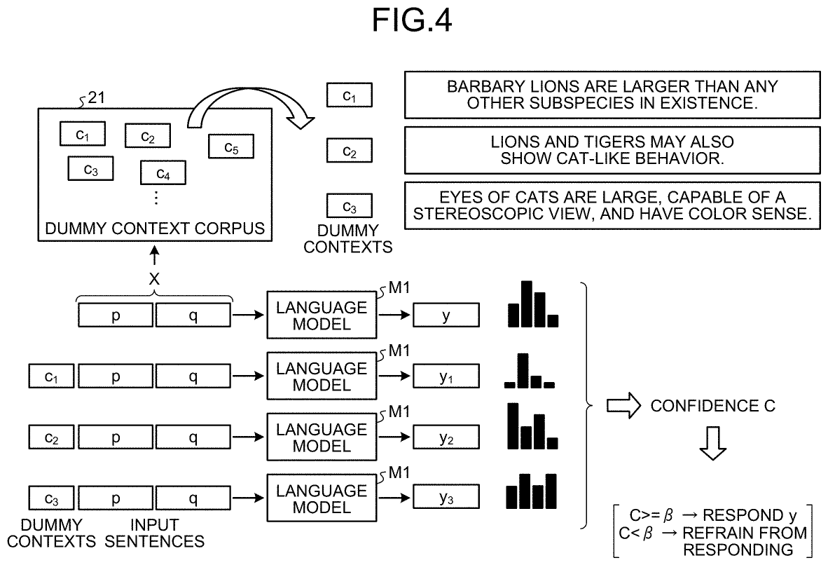

FIG. 4 is an explanatory diagram for explaining the calculation of the confidence C and the output of the response according to the confidence C. As illustrated in FIG. 4, the information processing apparatus 1 acquires, based on the input sentence x for which the contexts (p, q) are combined, those that are similar to the contexts (p, q) of the input sentence x as the dummy contexts (c₁, c₂, c₃) from the contexts (c₁, c₂, c₃, c₄, . . . ) included in the dummy context corpus 21.

Then, the information processing apparatus 1 inputs the combined sentences for which each of the dummy contexts (c₁, c₂, c₃) is combined with the input sentence x into the language model M1, and obtains the prediction labels (y₁, y₂, y₃) and the probability distribution of the labels.

Based on the difference between each probability distribution, the information processing apparatus 1 calculates the confidence C in the output when the input sentence x is input into the language model M1. Then, the information processing apparatus 1 outputs, based on the confidence C, the output result (y) when the input sentence x is input into the language model M1. Specifically, the information processing apparatus 1 compares the confidence C with a predetermined threshold value (β), and when C<β, refrains from responding y. When C≥β, the information processing apparatus 1 responds y.

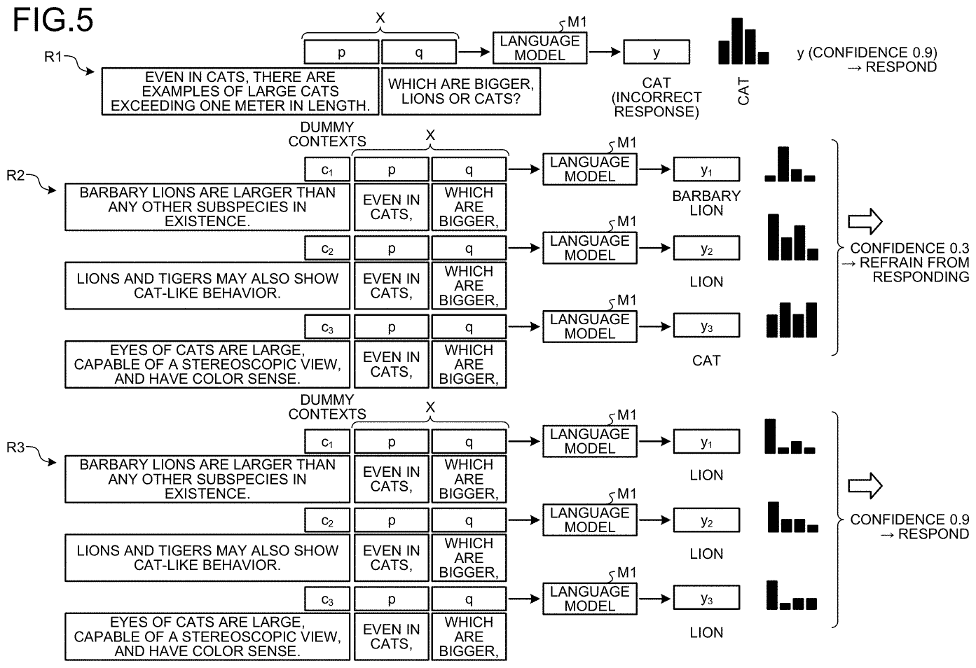

FIG. 5 is an explanatory diagram for explaining a specific example of responses for each case. In FIG. 5, the case R1 is a case where the output result (y) when the input sentence x is input into the language model M1 is an incorrect response. The case R2 is a case where the output result (y) when the input sentence x is input into the language model M1 is an incorrect response and responding is refrained based on the confidence C calculated by the information processing apparatus 1 according to the embodiment. The case R2 is a case where the output result (y) when the input sentence x is input into the language model M1 is a correct response and responding is carried out based on the confidence C calculated by the information processing apparatus 1 according to the embodiment.

As illustrated in the case R1, the value of the confidence C may become high (0.9 in the illustrated example) from the probability distribution in the output result (y) when the input sentence x is input into the language model M1. Thus, the incorrect response may be output as is.

The information processing apparatus 1 according to the embodiment obtains the confidence C based on the difference (degree of change) obtained by comparing the probability distribution of the combined sentences for which each of the dummy contexts (c₁, c₂, c₃) is combined with the input sentence x.

As a result, in the case R2 where the difference in the probability distribution is large and the context-dependency of the dummy contexts (c₁, c₂, c₃) with respect to the output result when the input sentence x is input into the language model M1 is high, the value of the confidence C for the incorrect response becomes low (0.3 in the illustrated example). Thus, in the case R2, the response by the language model M1 is refrained, assuming that it is likely to be incorrect.

Furthermore, in the case R3 where the difference in the probability distribution is small and the context-dependency of the dummy contexts (c₁, c₂, c₃) for the output result when the input sentence x is input into the language model M1 is low, the value of the confidence C for the correct response becomes high (0.9 in the illustrated example). Thus, in the case R3, the response by the language model M1 is output, assuming that it is likely to be the correct response. In this way, the information processing apparatus 1 according to the embodiment can assist optimization of the output of the language model M1.

As in the foregoing, the information processing apparatus 1 acquires a plurality of word strings (c₁, c₂, c₃, . . . ) relating to the target sentence (input sentence x). The information processing apparatus 1 inputs each of a plurality of combined sentences for which each of the acquired word strings is combined with the target sentence, and the target sentence into the language model M1. The information processing apparatus 1 calculates, based on the difference between each distribution of the output result when each of the combined sentences is input into the language model M1, the confidence C in the output when the target sentence is input into the language model M1. The information processing apparatus 1 outputs, based on the calculated confidence C, the output result when the target sentence is input into the language model M1.

The difference between each distribution of the output result in the combined sentences represents the context-dependency of the output result of the language model M1 for the target sentence. Thus, the information processing apparatus 1 can obtain the confidence according to the context-dependency of the output result of the language model M1 for the target sentence and carries out outputting the language model M1 based on the confidence, so that it can assist optimization of the output of the language model M1.

In addition, the information processing apparatus 1 calculates the variance based on each distribution of the output result when each of the combined sentences is input into the language model M1, and assumes the calculated variance to be the index value of the confidence C. This allows the information processing apparatus 1 to assume the variance based on each distribution of the output result in the combined sentences to be the index value of the confidence C and to obtain the confidence C in consideration of the context-dependency.

The information processing apparatus 1 calculates the distance based on each distribution of the output result when each of the combined sentences is input into the language model M1, and assumes the calculated distance to be the index value of the confidence C. This allows the information processing apparatus 1 to assume the distance based on each distribution of the output result in the combined sentences to be the index value of the confidence C and to obtain the confidence C in consideration of the context-dependency.

The information processing apparatus 1 acquires, based on the similarity to the target sentence, a plurality of word strings (c₁, c₂, c₃, . . . ) relating to the target sentence in the dummy context corpus 21. This allows the information processing apparatus 1 to acquire the word strings relating to the target sentence from the dummy context corpus 21.

The respective constituent elements of the various devices illustrated in the drawings do not necessarily need to be physically configured as illustrated in the drawings. In other words, the specific embodiments of distribution or integration of the various devices are not limited to those illustrated, and the whole or a part thereof can be configured by being functionally or physically distributed or integrated in any unit, according to a variety of loads and usage.

Furthermore, the various processing functions of the dummy-context acquisition unit 31, the response acquisition unit 32, the confidence calculation unit 33, and the output unit 34 performed in the control unit 30 of the information processing apparatus 1 may be configured such that the whole or any part thereof is executed on a CPU (or on a micro-computer such as an MPU or micro controller unit (MCU)). The various processing functions may be configured such that the whole or any part thereof is executed on a computer program analyzed and executed by the CPU (or a micro-computer such as an MPU and an MCU) or executed on the hardware by wired logic. The various processing functions performed in the information processing apparatus 1 may be collaboratively executed by a plurality of computers using cloud computing.

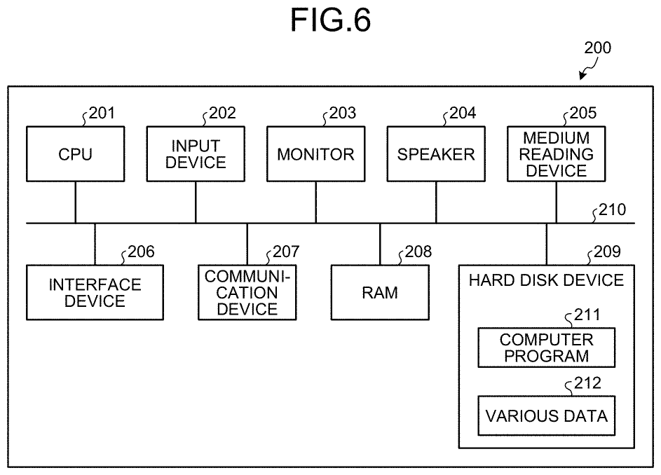

Incidentally, the various processing explained in the above-described embodiment can be implemented by executing a computer program prepared in advance on a computer. Thus, the following describes one example of a computer configuration (hardware) that executes a computer program having the same functions as those of the above-described embodiment. FIG. 6 is an explanatory diagram for explaining one example of a computer configuration.

As illustrated in FIG. 6, a computer 200 includes a CPU 201 that executes various arithmetic processes, an input device 202 that receives data input, a monitor 203, and a speaker 204. The computer 200 further includes a medium reading device 205 that reads computer programs and the like from a storage medium, an interface device 206 for connecting to various devices, and a communication device 207 for connecting to communicate with external devices in a wired or wireless manner. The information processing apparatus 1 further includes a RAM 208 that temporarily stores therein a variety of information, and a hard disk device 209. Various units (201 to 209) within the computer 200 are connected to a bus 210.

The hard disk device 209 stores therein a computer program 211 to execute various processing in the functional configuration (for example, the dummy-context acquisition unit 31, the response acquisition unit 32, the confidence calculation unit 33, and the output unit 34) described in the above-described embodiment. In addition, the hard disk device 209 stores therein various data 212 to which the computer program 211 refers. The input device 202 receives the input of operating information from an operator, for example. The monitor 203 displays various screens on which the operator manipulates, for example. The interface device 206 connects to a printing device and the like, for example. The communication device 207 is connected to a communication network such as a local area network (LAN) and exchanges various information with external devices via the communication network.

The CPU 201 reads out the computer program 211 stored in the hard disk device 209, and loads and executes it on the RAM 208, thereby performing various processing concerning the above-described functional configuration (for example, the dummy-context acquisition unit 31, the response acquisition unit 32, the confidence calculation unit 33, and the output unit 34). The computer program 211 does not necessarily need to be kept stored in the hard disk device 209. For example, the computer 200 may be configured to read out and execute the computer program 211 stored in a computer-readable storage medium. The storage medium that the computer 200 can read corresponds to a portable recording medium such as a CD-ROM, a DVD disc, and a universal serial bus (USB) memory; a semi-conductor memory such as a flash memory; and a hard disk drive, for example. The computer 200 may further be configured, by storing this computer program 211 on devices connected to a public line, the Internet, a LAN, and the like, to read out and execute the computer program 211 from these devices.

Optimization of the output of the language model can be assisted.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
acquiring a plurality of word strings relating to a target sentence;
inputting each of a plurality of combined sentences for which each of the acquired word strings is combined with the target sentence, and the target sentence into a language model, generated by using a machine learning;
calculating, based on a difference between each distribution of an output result when each of the combined sentences is input into the language model, confidence in output when the target sentence is input into the language model; and
outputting, based on the calculated confidence, an output result when the target sentence is input into the language model.

2. The non-transitory computer-readable recording medium according to claim 1, wherein the calculating calculates variance based on each distribution and assumes the calculated variance to be an index value of the confidence.

3. The non-transitory computer-readable recording medium according to claim 1, wherein the calculating calculates a distance based on each distribution and assumes the calculated distance to be an index value of the confidence.

4. The non-transitory computer-readable recording medium according to claim 1, wherein the acquiring acquires, based on similarity to the target sentence, a plurality of word strings relating to the target sentence in a corpus.

5. An information processing method comprising:
acquiring a plurality of word strings relating to a target sentence;
inputting each of a plurality of combined sentences for which each of the acquired word strings is combined with the target sentence, and the target sentence into a language model, generated by using a machine learning;
calculating, based on a difference between each distribution of an output result when each of the combined sentences is input into the language model, confidence in output when the target sentence is input into the language model; and
outputting, based on the calculated confidence, an output result when the target sentence is input into the language model.

6. The information processing method according to claim 5, wherein the calculating calculates variance based on each distribution and assumes the calculated variance to be an index value of the confidence.

7. The information processing method according to claim 5, wherein the calculating calculates a distance based on each distribution and assumes the calculated distance to be an index value of the confidence.

8. The information processing method according to claim 5, wherein the acquiring acquires, based on similarity to the target sentence, a plurality of word strings relating to the target sentence in a corpus.

9. An information processing apparatus comprising a control unit that executes a process comprising:
acquiring a plurality of word strings relating to a target sentence;
inputting each of a plurality of combined sentences for which each of the acquired word strings is combined with the target sentence, and the target sentence into a language model, generated by using a machine learning;
calculating, based on a difference between each distribution of an output result when each of the combined sentences is input into the language model, confidence in output when the target sentence is input into the language model; and
outputting, based on the calculated confidence, an output result when the target sentence is input into the language model.

10. The information processing apparatus according to claim 9, wherein the calculating calculates variance based on each distribution and assumes the calculated variance to be an index value of the confidence.

11. The information processing apparatus according to claim 9, wherein the calculating calculates a distance based on each distribution and assumes the calculated distance to be an index value of the confidence.

12. The information processing apparatus according to claim 9, wherein the acquiring acquires, based on similarity to the target sentence, a plurality of word strings relating to the target sentence in a corpus.
